(19) United States
(12) Patent Application Publication
(10) Pub. No.: US 2026/0141389 A1
(43) Pub. Date: May 21, 2026

(54) SYSTEMS AND METHODS FOR CROSS-ISSUER CHARGEBACK FRAUD DETECTION SYSTEM

(71) Applicant: Worldpay, LLC, Symmes Township, OH (US)

(72) Inventors: Nicole S. JASS, Aurora, CO (US); David MATTEI, Loveland, OH (US); Dennis KETTLER, Lebanon, OH (US)

(21) Appl. No.: 17/936,450

(22) Filed: Sep. 29, 2022

Related U.S. Application Data
(63) Continuation of application No. 15/825,255, filed on Nov. 29, 2017, now abandoned.

(51) Int. Cl. G06Q 20/40

(52) U.S. Cl. CPC G06Q 20/4016; G06Q 20/4014; G06Q 20/407

(57) ABSTRACT

A method for establishing a cross-issuer chargeback fraud detection system includes receiving a fraud analysis request for one or more chargebacks from a payment processor using an Application Programming Interface (API) over a computer network, extracting identifying information of transactions associated with the one or more chargebacks from the fraud analysis request, searching for a fraud analysis profile linked to the extracted identifying information in a profile database, determining whether the fraud analysis profile linked to the extracted identifying information exists in the profile database, upon determining that the fraud analysis profile linked to the extracted identifying information does not exist in the profile database, retrieving historical transaction data associated with the extracted identifying information from a historical transaction database, retrieving reported fraudulent activities from one or more financial institutions associated with the extracted identifying information, and aggregating the retrieved historical transaction data and reported fraudulent activities.

### TECHNICAL FIELD

Various embodiments of the present disclosure relate generally to electronic payment fraud detection infrastructure and, more particularly, detecting fraudulent transactions across multiple issuers.

### BACKGROUND

An average consumer in the United States carries about four to six credit and/or debit cards in their wallet and may use different cards for different types of transactions. Traditionally, financial institutions (e.g., banks) monitor an individual credit or debit card to check for any fraudulent activities. Most transaction fraud systems monitor cardholder's buying behavior at the individual card level. However, monitoring transaction at a card level provides a limited view of the spending patterns of a consumer. Furthermore, monitoring transactions for fraudulent activities at individual card level does not help identify a habitual offender requesting chargebacks.

Chargebacks may be required for certain online or brick-and-mortar payment transactions in situations of duplicate billing, a consumer returning a product, or fraudulent transactions. A chargeback is a fraudulent transaction if a purchase is made using the consumer's payment card without the consumer's knowledge. In an alternative scenario, the consumer may not be honest in requesting a chargeback. For example, the consumer may dispute a chargeback for a product even after intentionally buying the product, which may result in a merchant losing revenue. Transactional monitoring of buying behavior for fraudulent activities at an individual card level may not identify fraudulent chargebacks accurately, since some fraudulent activity may go unnoticed, whereas valid transaction may be inadvertently declined. The most common solution today is to decline suspicious transactions even without confirmation of fraud, which then typically prompts the consumer to use a different credit/debit card to complete the transaction. This practice further results in a poor consumer experience. The traditional practice also leads to lost revenue opportunity for the merchant and financial institution when a consumer fraudulently reports chargebacks for valid transactions using debit/credit cards issued by multiple issuers.

The present disclosure is directed to overcoming one or more of these above-referenced challenges.

### SUMMARY OF THE DISCLOSURE

According to certain aspects of the disclosure, systems and methods are disclosed for establishing a cross-issuer chargeback fraud detection system for chargebacks reported by an individual to one or more issuers.

In an example embodiment, a method for establishing a cross-issuer chargeback fraud detection system includes receiving a fraud analysis request for one or more chargebacks from a payment processor using an Application Programming Interface (API) over a computer network, extracting identifying information of transactions associated with the one or more chargebacks from the fraud analysis request, searching for a fraud analysis profile linked to the extracted identifying information in a profile database, determining whether the fraud analysis profile linked to the extracted identifying information exists in the profile database, upon determining that the fraud analysis profile linked to the extracted identifying information does not exist in the profile database, retrieving historical transaction data associated with the extracted identifying information from a historical transaction database, retrieving reported fraudulent activities from one or more financial institutions associated with the extracted identifying information, and aggregating the retrieved historical transaction data and reported fraudulent activities.

In the above example embodiment, the historical transaction data associated with the at least one of retrieved account identification and PII from the historical transaction database comprises at least one of a merchant's identification, location and terminal information, a source IP address, a date and a time, device information, and a transaction amount of the purchase transactions. The historical transaction database may be generated by retrieving historical transaction data for an online or brick-and-mortar payment transaction before the online or brick-and-mortar payment transaction is sent to a financial institution for authorization.

In the above-illustrated embodiment, the method further includes: generating a fraud analysis profile request, wherein the fraud analysis profile request includes a unique profile identifier and at least one of aggregated historical transaction data and reported fraudulent activities, tokenizing the identifying information of transactions associated with the one or more chargebacks within the fraud analysis profile request, sending the fraud analysis profile request to a cloud platform for analysis, receiving a fraud analysis profile from the cloud platform, detokenizing the identifying information of transactions associated with the one or more chargebacks within the received fraud analysis profile, and storing the detokenized fraud analysis profile into the profile database.

In an alternative embodiment, the method further includes: analyzing, as a result of determining the fraud analysis profile exists in the profile database, one or more chargebacks against the fraud analysis profile, determining a multidimensional score for the one or more chargebacks according to the analysis of one or more chargebacks against the fraud analysis profile, and sending the analysis and multidimensional score to the payment processor.

In the above embodiment, the fraud analysis request may comprise at least one of an account identification, PII, transaction detail, and a type of fraud analysis request for the one or more chargebacks, and wherein the PII comprises at least one of a name, an address, a social security number, and an email address. In an example embodiment, PII may comprise at least one of name, address, social security number, and email address. In the above explained embodiment, the fraud analysis profile may include at least one of spending irregularities and suspicious activities associated with the account identification and the PII.

In an example embodiment, the spending irregularities are calculated based on at least one of the individual's spending patterns, a geographic region of an IP address, a billing address, and a type of payment card. The analysis of the one or more chargeback(s) may include a comparison of the one or more chargebacks against the spending irregularities and the suspicious activities provided in the fraud analysis profile. Additionally, the transaction detail may comprise at least one of a transaction amount, a merchant identification, and a date and time of the one or more chargeback(s). The type of fraud analysis profile request may comprise a fraud analysis request for transactions within a specified value of the goods and services. In an example embodiment, the fraud analysis profile may provide one or more fraud alert parameters for future transactions to the payment processor.

In accordance with another embodiment, a system is disclosed for establishing a cross-issuer chargeback fraud detection system. The system comprises: a memory having processor-readable instructions stored therein; and a processor configured to access the memory and execute the processor-readable instructions, which when executed by the processor configures the processor to perform a plurality of functions, including functions for: receiving a fraud analysis request for one or more chargebacks from a payment processor using an Application Programming Interface (API) over a computer network, extracting identifying information of transactions associated with the one or more chargebacks from the fraud analysis request, searching for a fraud analysis profile linked to the extracted identifying information in a profile database, determining whether the fraud analysis profile linked to the extracted identifying information exists in the profile database, upon determining that the fraud analysis profile linked to the extracted identifying information does not exist in the profile database, retrieving historical transaction data associated with the extracted identifying information from a historical transaction database, retrieving reported fraudulent activities from one or more financial institutions associated with the extracted identifying information, and aggregating the retrieved historical transaction data and reported fraudulent activities.

In accordance with another embodiment, a non-transitory machine-readable medium is disclosed that stores instructions that, when executed by a computer, cause the computer to perform a method for establishing a cross-issuer chargeback fraud detection system. The method includes: receiving a fraud analysis request for one or more chargebacks from a payment processor using an Application Programming Interface (API) over a computer network, extracting identifying information of transactions associated with the one or more chargebacks from the fraud analysis request, searching for a fraud analysis profile linked to the extracted identifying information in a profile database, determining whether the fraud analysis profile linked to the extracted identifying information exists in the profile database, upon determining that the fraud analysis profile linked to the extracted identifying information does not exist in the profile database, retrieving historical transaction data associated with the extracted identifying information from a historical transaction database, retrieving reported fraudulent activities from one or more financial institutions associated with the extracted identifying information, and aggregating the retrieved historical transaction data and reported fraudulent activities.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims. As will be apparent from the embodiments below, an advantage to the disclosed systems and methods is that multiple parties may fully utilize their data without allowing others to have direct access to raw data.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts a block diagram of a chargeback fraud detection system infrastructure for a brick-and-mortar payment or an online transaction.

FIG. 2 depicts a schematic diagram of the cross-issuer chargeback fraud detection system of FIG. 1.

FIG. 3 depicts a flowchart of a method for generating a cross-issuer chargeback fraud detection report for one or more chargeback(s), according to one or more embodiments.

FIG. 4 depicts a flowchart of a method for establishing a fraud analysis profile associated with an individual reporting one or more chargeback(s), according to one or more embodiments.

FIG. 5 depicts an exemplary presentation of a fraud detection analysis to a requester issuer, according to one or more embodiments.

FIG. 6 depicts an example of a computing device.

### DETAILED DESCRIPTION OF EMBODIMENTS

Various embodiments of the present disclosure relate generally to analyzing an online or brick-and-mortar payment transaction submitted for a chargeback for a fraudulent activity according to an individual or a household fraud analysis profile.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

As described above, there is a need for a universal fraud analysis profile that associates transaction data across multiple credit and debit cards in a consumer's wallet to create a more complete picture of the buying behavior of the consumer. Historical transaction data may be aggregated in a cross-issuer database and indexed to consumers and/or households using personally identifying information (PII) leveraged from e-commerce data, such as by e-mail address, mailing address, or other unique identifier (e.g., a hash or alpha-numeric code), or other identifying information associated with the transactions. The identifying information associated with the transactions may include, for example, personally identifiable information (PII) of an individual associated with the transaction, a device fingerprint, device-specific information, an originating IP address, which may be determined through IP proxy piercing, etc. This information may then be used to train and execute an aggregated fraud scoring system to better predict and act on fraudulent chargebacks, regardless of which issuer and/or issuer processor is associated with each card. Thus, various embodiments of the present disclosure relate generally to analyzing chargeback(s) against historical online or brick-and-mortar transactions across data aggregated from across card issuers for fraudulent activity.

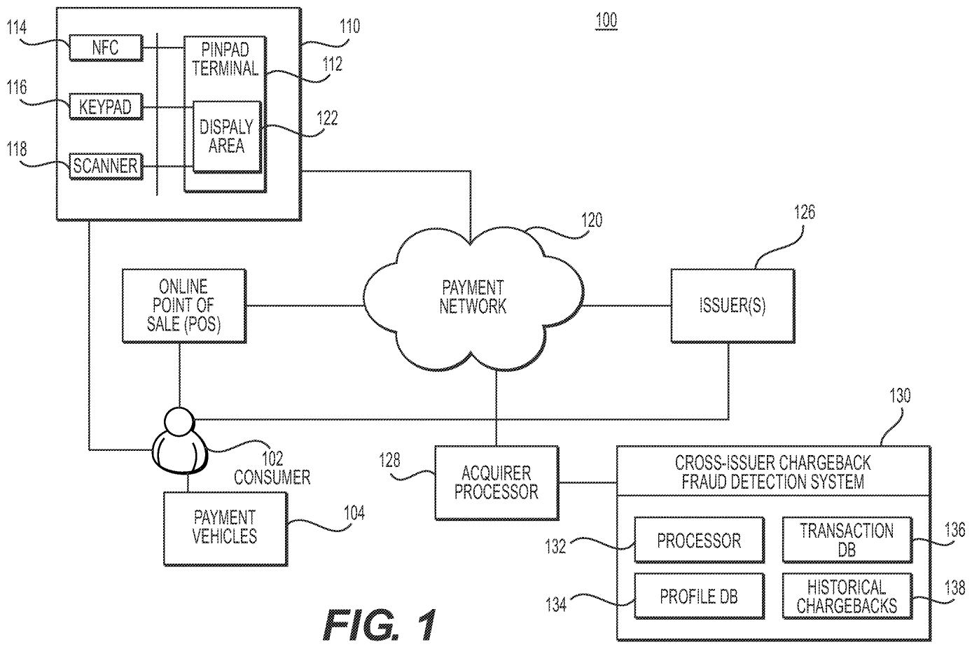

Turning to FIG. 1, traditionally, in an electronic payment processing system, a consumer 102, during the checkout process with a merchant 110, pays for goods or services from merchant 110 at a PIN Pad 112. Consumer 102 may use a payment card as payment vehicle 104. The payment vehicle 104 used by the consumer is usually issued by financial institutions (e.g., banks) where the consumer keeps his/her funds in a savings or checking account, or by credit issuing companies that bill the consumer on a monthly basis. In one or more embodiments, the payment vehicles may be payment cards using computer chips to authenticate transactions according to Europay, MasterCard, and Visa (EMV) global standard or contactless payment vehicles using EMV or NFC technologies.

Because merchant 110 generally can use a different bank or financial institution 126 than consumer 102, an acquirer processor 128 handles the financial transactions that transfer payment between the financial institution 126 of consumer 102 and that of merchant 110. Consumer 102 submits payment information at the PIN Pad 112 associated with POS terminal of merchant 110, such as by swiping his or her payment card, inserting his or her chip-based payment card, through wireless near field communication (NFC), etc., or by any other suitable means. PIN Pad 112 sends a payment request by way of a computer network 120 to an acquirer processor 128. Alternatively, such a request may be sent by a component that controls a flow of a transaction, such as point of sale (POS) 130. Acquirer processor 128 requests, by way of payment network 120, an electronic transfer of funds from the received funds to the financial institution 126 (e.g., issuer(s)) associated with merchant 110.

Merchant 110 may provide an infrastructure for processing electronic payment requests. FIG. 1 depicts a typical payment processing infrastructure (e.g., NFC 114, Keypad 116, Scanner 118, PIN Pad Terminal 112) for payment processing within a merchant environment, according to one or more embodiments. In an example embodiment, a consumer 102 may use one or more payment vehicles 104 for transactions at merchant 110.

In an example embodiment, as shown in FIG. 1, the acquirer processor may communicate with a cross-issuer chargeback fraud detection system 130 may include a processor 132, profile database 134, historical transactional database 136, and historical chargeback(s) 138. The profile database 134 for an individual may comprise a unique identifier hash recognizing the profile associated with the individual's payment vehicles (e.g., debit, credit cards), personally identifiable information (PII), identifying information of transactions associated with the individual, and analysis of an individual's spending habits, geographic area, fraud activities reported on the cards associated with the individual. In an example embodiment, the personally identifiable information (PII) about the individual may include at least one of his/her name, email address, date of birth, social security number, and physical address. The historical transaction database 136 may comprise transaction data associated with the payment vehicle 104. The transaction database 136 may comprise tables containing information associated with one or more transaction(s), such as, for example, a source ID, a terminal ID, a date and time of the transaction, an IP address, a location of the transaction, and a transaction amount. In an example embodiment, historical chargeback database 138 may comprise chargeback history associated with the individual from one or more issuer(s) 126.

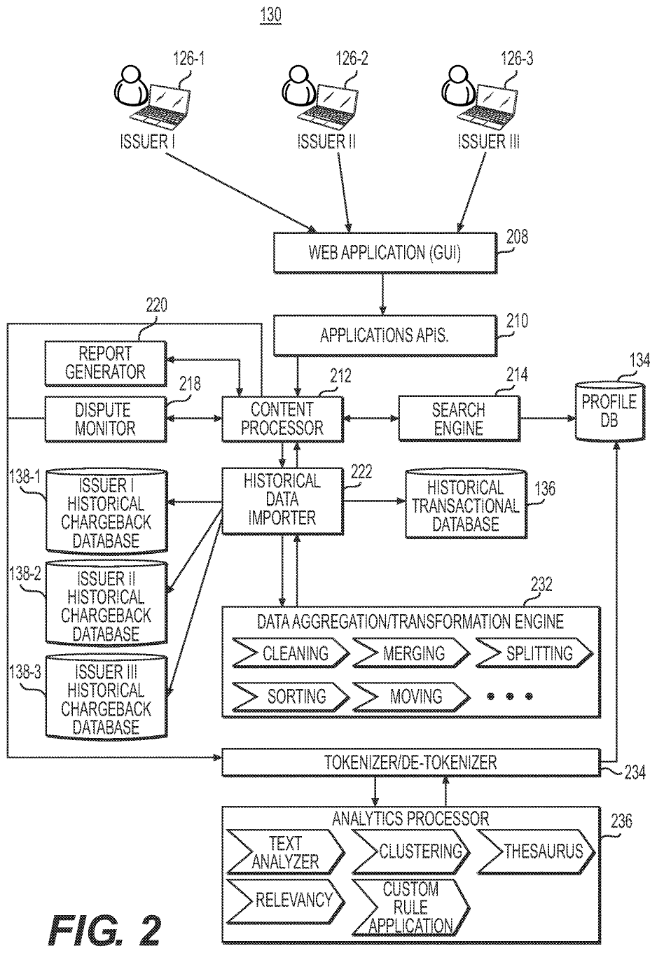

Turning to FIG. 2, in an example embodiment, cross-issuer chargeback fraud detection system 130 may receive one or more chargeback(s) analysis requests from one or more issuers (e.g., Issuer I 126-1, Issuer II 126-2, and/or Issuer III 126-3). The cross-issuer chargeback fraud detection system 130 may comprise content processor 212, search engine 214, report generator 220, historical data importer 222, and dispute monitor 218. The cross-issuer chargeback fraud detection system 130 may include profile database 134 and historical chargeback database from issuer(s) (e.g., 138-1, 138-2, 138-3). In the above-illustrated embodiment, the cross-issuer chargeback fraud detection system 130 may comprise data aggregation/transaction engine (232), tokenizer/de-tokenizer 234, and analytics processor 236.

In an example embodiment, the issuers (126-1, 126-2, 126-3) may submit chargeback fraud analysis request using a web application 208 over a computer network. In an example embodiment, issuers may use an Application Programming Interface (API) and Hypertext Transfer Protocol (HTTP). The issuers may use HTTP CRUD (Create, Read, Update, Delete) operations to send the fraud analysis request to the content processor 212.

In the above-illustrated embodiment, the content processor 212 may extract at least one of identifying information of transactions associated with the individual, Personally Identifiable Information (PII) and a unique account identification from the fraud analysis request submitted by the issuers (e.g., 126-1, 126-2, 126-3). The content processor 212 may query the search engine 214 (e.g., processor) to retrieve a fraud analysis profile associated with the identifying information, PII or the unique account identification. The search engine 214 may search for the fraud analysis profile in a profile database 134.

In an example embodiment, search engine 214 may find the fraud analysis profile for the queried chargeback(s) analysis request. The search engine 214 may further determine whether the fraud analysis profile is generated within a specific time period (e.g., date and time) provided by the content processor 212. The search engine 214 may deliver the fraud analysis profile to the content processor 212 if the fraud analysis profile is generated within the specific time period. The content processor 212 may analyze the chargeback against the fraud analysis profile. The fraud analysis profile may include spending irregularities or suspicious activities associated with the unique account identification or the individual. The content processor 212 may analyze the chargeback(s) against spending irregularities or suspicious activities provided in the fraud analysis profile. The content processor 212 may determine a multidimensional score for the chargeback(s) according to the analysis of chargeback(s) against the fraud analysis profile. The content processor 212 may present the analysis and multidimensional score to the requester issuer (126-1, 126-2, or 126-3) using a web interface, such as web application 208, over a computer network. In an alternative embodiment, the content processor 212 may utilize report generator 220 to analyze the chargeback against the fraud analysis profile and generate a report to be sent to the requesting issuer(s). The report could be sent to one or more issuer(s) using, for example, an API or email address of an agent requesting the issuer(s) chargeback analysis. Report generator 220 may be a cloud platform performing the analysis using HTTP protocol.

In an alternative embodiment, issuers (126-1, 126-2, 126-3) may configure the content processor 212 to retrieve fraud analysis profile for chargeback(s) within a specific range of values of goods and services. In a yet another embodiment, the content processor 212 may provide fraud alert parameters for future transactions to issuer(s). The fraud alert parameters may be at least one of geographical restrictions, merchant restrictions, purchase price restrictions, etc. In an example embodiment, report generator 220 may be a cloud platform (e.g., Web Service), where the report generator 220 may communicate with the content processor 212 using a Representational State Transfer (REST) Application Programming Interface (API). In an example embodiment, the dispute monitor 218 may be responsible for tracking the fraud analysis request and generating analysis report. The dispute monitor 218 may make calls to an API published by report generator 220 to track progress of analysis report generation and fraud analysis profile generation.

In an alternative embodiment, if the fraud analysis profile is not available for the requested chargeback analysis, search engine 214 may send a message to content processor 212. The content processor 212 may generate a unique hash and a fraud analysis profile request. The content processor 212 may send the fraud analysis profile request including the unique hash to historical data importer 222 to generate fraud analysis profile for received identifying information of transactions associated with the individual, PII, or unique account identification. The historical data importer 222 may further import historical chargeback disputes from one or more issuer(s) associated with at least one of the identifying information of transactions associated with the individual, PII, and unique account identification. The historical data importer 222 may further import historical transactions from historical transactional database 136. The historical transaction database 136 may comprise historical transactions from one or more issuer(s). The historical transactions may be retrieved from payment networks (120), as shown in FIG. 1, when transaction authorization requests are sent for a payment transaction from an online or brick-and-mortar merchant (110) from point of sale terminal to a financial institutions (e.g., Issuer(s) 126). Transaction information for historical transactions may be retrieved before the authorization requests are routed to the financial institutions (e.g., Issuer(s) 126).

The historical data importer 222 may send the retrieved historical chargeback data and historical transaction data along with a fraud analysis profile request to a data aggregation/transformation engine 232. The main tasks of data aggregation/transformation 232 may include data extraction, transformation, and loading into a temporary storage system. The data aggregation/transformation engine (e.g., processor) 232 may perform further operations such as data moving, cleaning, splitting, translation, merging, and sorting. The data aggregation/transformation engine 232 may store the transformed data in standard format such as, for example, in a relational database or a distributed file system.

In an alternative embodiment, a tokenizer 234 may tokenize the identifying information of transactions associated with the individual, PII, and the unique account identification associated with the aggregated data. The tokenized data may be further sent to analytics processor 236 for analyzing aggregated data and generating a fraud analysis profile. The analytics processor 236 may use text analyzer, clustering, thesaurus, relevancy, and other custom rules to analyze the aggregated data and generate the fraud analysis profile. A de-tokenizer 234 may de-tokenize the generated fraud analysis profile and store the profile in the profile database 134. In an example embodiment, the dispute monitor 218 may notify the content processor 212 once the profile is generated and stored into the profile database 134. The content processor 212 may analyze one or more chargeback transaction(s) against the generated fraud analysis profile, determine a multidimensional score, and send the analysis and multidimensional score to the requesting issuer(s).

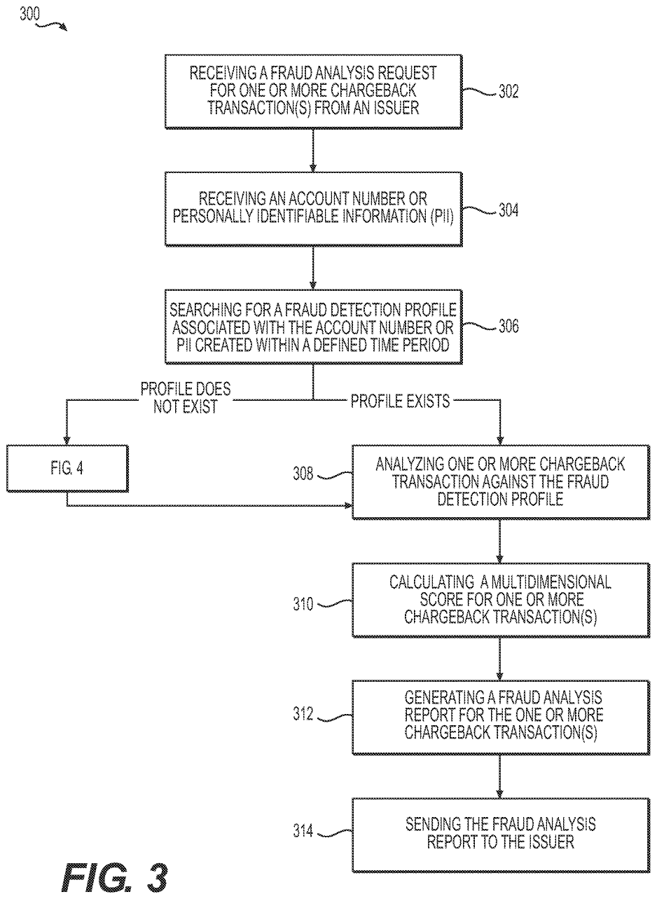

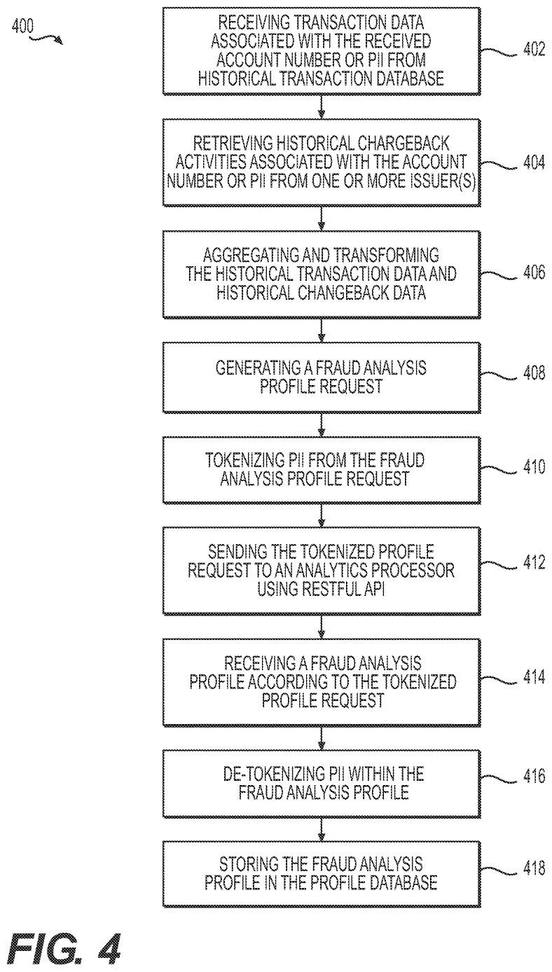

According to one or more embodiments, the components of infrastructure shown in FIGS. 1 and 2 may be connected by a computer network, such as, for example a local area network (LAN) or a wireless network, such as, for example, a WiFi network. However, other network connections among the components of infrastructure shown in FIGS. 1 and 2 may be used, such as, for example, a wide area network (WAN), the internet, or the cloud. Methods of establishing cross-issuer chargeback fraud detection system 130 for chargebacks according to one or more embodiments will be discussed with respect to FIGS. 3-4 below. Functions of the components of infrastructure 100 will be described below with respect to exemplary methods for cross-issuer chargeback fraud detection system 130.

FIGS. 1 and 2 and the discussion above provide a brief, general description of a suitable computing environment in which the present disclosure may be implemented. In one embodiment, any of the disclosed systems, methods, and/or graphical user interfaces may be executed by or implemented by a computing system consistent with or similar to that depicted in FIGS. 1 and 2. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

FIG. 3 illustrates a flowchart for generating a cross-issuer chargeback fraud detection report, such as by system 130. The cross-issuer chargeback fraud detection system 130 may comprise a processor 132, as shown in FIG. 1. The processor 132 may receive a fraud analysis request for one or more chargebacks from a payment processor (e.g., issuer(s) 126) using an API over a computer network, according to operation 302. In an example embodiment, the processor 132 may extract at least one of identifying information of transactions associated with the individual, an account identification, and PII from the fraud analysis request according to operation 304. At operation 306, the processor 132 may further search for a fraud analysis profile linked to at least one of the identifying information of transactions associated with the individual, account identification, and PII in a profile database 134. The processor 132 may further determine whether a fraud analysis profile is generated within a defined time period according to operation 306. The defined time period may be customizable parameter (e.g., block of dates) submitted by the requesting payment processor (issuer(s) 126).

In an example embodiment, as described in operation 308, processor 132 may analyze, as a result of determining that a fraud analysis profile generated within the defined time period does not exist in profile database 134, historical transaction data associated with the at least one of retrieved identifying information of transactions associated with the individual, account identification, and PII from a historical transaction database 136. In an example embodiment, according to operation 310, processor 132 may determine a multidimensional score for the one or more chargeback transaction(s) according to the analysis of one or more chargeback transaction(s) against the fraud analysis profile and send the analysis and multidimensional score to the payment processor (e.g., issuer 126), according to operations 312 and 314.

FIG. 4 depicts a flowchart of a method for establishing a fraud analysis profile associated with an individual reporting one or more chargeback(s), according to one or more embodiments. In one or more embodiments, processor 132, as a result of determining that a fraud analysis profile linked to at least one of the identifying information of transactions associated with the individual, account identification, and PII does not exist in the profile database and has not been generated within the defined time period, may receive historical transaction data associated with the at least one of retrieved identifying information of transactions associated with the individual, account identification, and PII from a historical transaction database 136, as per operation 402. Processor 132 may also retrieve reported fraudulent activities from one or more financial institution(s) 126 associated with the at least one of retrieved identifying information of transactions associated with the individual, account identification, and PII according to operation 404. In operation 406, processor 132 may further aggregate the retrieved historical transaction data and reported fraudulent activities in a temporary data storage.

In an example embodiment, moving to operation 408, the processor 132 may further generate a fraud analysis profile request, wherein the fraud analysis profile request includes at least one of aggregated historical transaction data and reported fraudulent activities, and a unique profile identifier. Processor 132 may tokenize at least one of the identifying information of transactions associated with the individual, PII, and the account identification within the fraud analysis profile request according to operation 410. Processor 132 may further send the fraud analysis profile request to a cloud platform for analysis using a Representational State Transfer (REST) API, as per operation 412. Processor 132 may further receive a fraud analysis profile from the cloud platform using the REST API and may detokenize the at least one of identifying information of transactions associated with the individual, PII, and the account identification within the received fraud analysis profile according to operation 414. Processor 132 may store the detokenized fraud analysis profile into profile database 134 according to operations 416 and 418. In an above-illustrated embodiment, the fraud analysis profile may include at least one of spending irregularities and suspicious activities associated with the identifying information of transactions associated with the individual, account identification, and PII. The spending irregularities may be calculated based on, for example, at least one of the individual's spending patterns, geographic region of IP address, billing address, and a type of payment card. The historical transaction data may be associated with the at least one of retrieved identifying information of transactions associated with the individual, account identification, and PII from the historical transaction database 136, and may comprise at least one of a merchant's identification, a location and terminal information, a source IP address, a date and time, device information, and a transaction amount for each of one or more purchase transactions. The type of fraud analysis profile request may comprise of a fraud analysis request for transactions within a specified value of the goods and services.

In the above example embodiment, historical transaction database 136 is generated by retrieving historical transaction data from an online or brick-and-mortar payment transaction before the online or brick-and-mortar payment transaction is sent to a financial institution for an authorization. The analysis of the one or more chargeback(s) may include comparison of one or more chargeback(s) against the spending irregularities and suspicious activities provided in the fraud analysis profile. In the above example embodiment, the fraud analysis profile may provide one or more fraud alert parameters for future transactions to the payment processor (e.g., Issuer(s) 126).

In one embodiment, the fraud analysis profile data may be at least one of the individual's spending irregularities and analysis of reported fraudulent activity associated with the payment cards linked to an individual. In an alternative embodiment, processor 132 may search profile database 136 to find an individual profile or household profile related to the retrieved PII. In an example embodiment, processor 136 may analyze the online or brick-and-mortar payment transaction against profile data associated with each member of the household or an individual. The spending irregularities of the individual fraud analysis profile may be computed according to the individual's spending habits, geographic area, and type of payment cards using for those payments. Additionally, the personally identifiable information (PII) may comprise of at least one of name, physical address, email address, etc. of the individual. In a different exemplary embodiment, processor 128 may search for both household profile and an individual profile for the retrieved PII in prolife database 136. The search may derive either the household or an individual profile the retrieved PII in profile database 136.

Processor 132 may send a notification to the financial institution (e.g., issuers 126) reporting fraudulent activity it determines among requested chargeback(s) of either online or brick-and-mortar payment transaction. The financial institution 126 may reject the online or brick-and-mortar payment transaction according to the notification provided from acquirer processor 128. Processor 132 may provide a score embedded with every transaction to the financial institutions 126. The multidimensional score may be a score representing a probability of a fraudulent transaction.

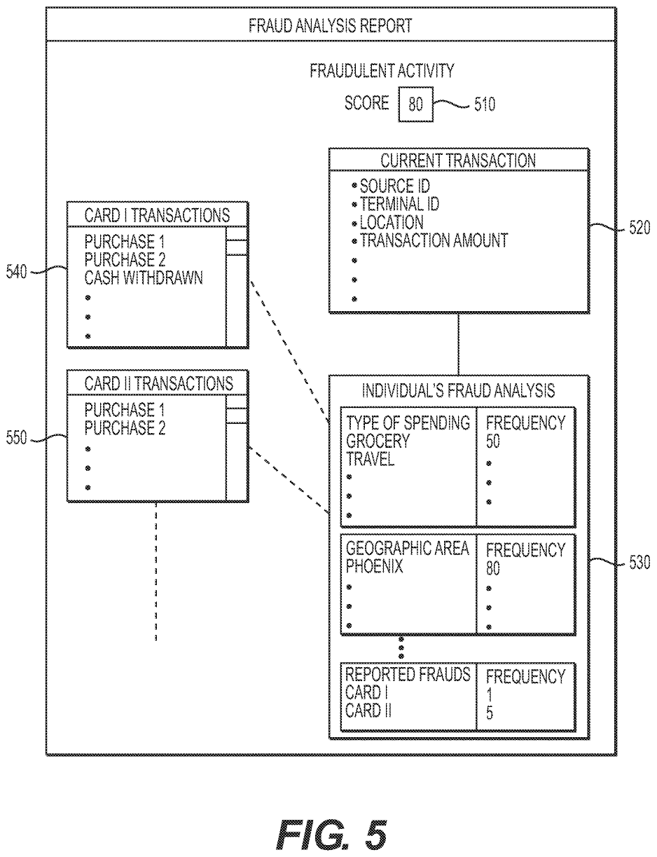

FIG. 5 is an example representation of a chargeback(s) analysis such as may be presented to financial institution(s) 126. The presentation further provides relevant historical chargeback(s) and historical transaction data to view to the financial institution in box 520. The individual fraud analysis 530 may include frequencies of spending habits, irregularities, geographic area and reported fraudulent activities. The fraudulent activity score 510 may be determined according to the frequencies of spending habits, irregularities, geographic area and reported fraudulent activities shown in 530.

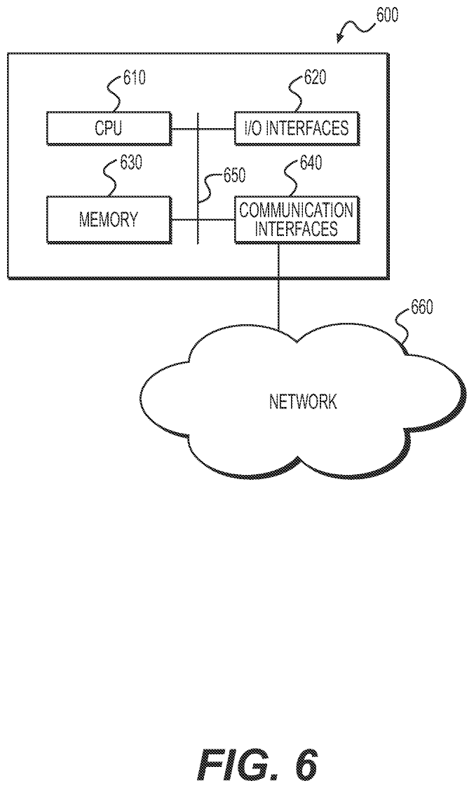

The systems and processes described above performed by processor 132 (or content processor 212) may be performed on or between one or more computing devices. FIG. 6 illustrates an example computing device. A computing device 600 may be a server, a computing device that is integrated with other systems or subsystems, a mobile computing device such as a smart phone, a cloud-based computing ability, and so forth. The computing device 600 may be any suitable computing device as would be understood in the art, including without limitation, a custom chip, and embedded processing device, a tablet computing device, a POS terminal associated with the merchant 110, a back-office system of a merchant 110, a personal data assistant (PDA), a desktop, laptop, microcomputer, and minicomputer, a server, a mainframe, or any other suitable programmable device. In various embodiments disclosed herein, a single component may be replaced by multiple components and multiple components may be replaced by single component to perform a given function or functions. Except where such substitution would not be operative, such substitution is within the intended scope of the embodiments.

The computing device 600 includes a processor 602 that may be any suitable type of processing unit, for example a general-purpose central processing unit (CPU), a reduced instruction set computer (RISC), a processor that has a pipeline or multiple processing capability including having multiple cores, a complex instruction set computer (CISC), a digital signal processor (DSP), application specific integrated circuits (ASIC), a programmable logic devices (PLD), and a field programmable gate array (FPGA), among others. The computing resources may also include distributed computing devices, cloud computing resources, and virtual computing resources in general.

The computing device 600 also includes one or more memories 606, for example read-only memory (ROM), random access memory (RAM), cache memory associated with the processor 602, or other memory such as dynamic RAM (DRAM), static RAM (SRAM), programmable ROM (PROM), electrically erasable PROM (EEPROM), flash memory, a removable memory card or disc, a solid-state drive, and so forth. The computing device 600 also includes storage media such as a storage device that may be configured to have multiple modules, such as magnetic disk drives, floppy drives, tape drives, hard drives, optical drives and media, magneto-optical drives and media, compact disk drives, Compact Disc Read Only Memory (CD-ROM), compact disc recordable (CD-R), Compact Disk Rewritable (CD-RW), a suitable type of Digital Versatile Disc (DVD) or Blu-ray disc, and so forth. Storage media such as flash drives, solid-state hard drives, redundant array of individual discs (RAID), virtual drives, networked drives and other memory means including storage media on the processor 602, or memories 606 are also contemplated as storage devices. It may be appreciated that such memory may be internal or external with respect to operation of the disclosed embodiments. It may be appreciated that certain portions of the processes described herein may be performed using instructions stored on a computer readable medium or media that direct computer system to perform the process steps. Non-transitory computable-readable media, as used herein, comprises all computer-readable media except for transitory, propagating signals.

Networking communication interfaces 612 may be configured to transmit to, or receive data from, other computing devices 600 across a network 614. The network and communication interfaces 612 may be an Ethernet interface, a radio interface, a Universal Serial Bus (USB) interface, or any other suitable communications interface and may include receivers, transmitter, and transceivers. For purposes of clarity, a transceiver may be referred to as a receiver or a transmitter when referring to only the input or only the output functionality of the transceiver. Example communication interfaces 612 may include wire data transmission links such as Ethernet and TCP/IP. The communication interfaces 612 may include wireless protocols for interfacing with private or public networks 614. For example, the network and communication interfaces 612 and protocols may include interfaces for communicating with private wireless networks such as Wi-Fi network, one of the IEEE 802.11x family of networks, or another suitable wireless network. The network and communication interfaces 612 may include interfaces and protocols for communicating with public wireless networks 614, using for example wireless protocols used by cellular network providers, including Code Division Multiple Access (CDMA) and Global System for Mobile Communications (GSM). A computing device 600 may use network and communication interfaces 612 to communicate with hardware modules such as a database or data store, or one or more servers or other networked computing resources. Data may be encrypted or protected from unauthorized access.

In various configurations, the computing device 600 may include a system bus 610 for interconnecting the various components of the computing device 600, or the computing device 600 may be integrated into one or more chips such as programmable logic device or application specific integrated circuit (ASIC). The system bus 616 may include a memory controller, a local bus, or a peripheral bus for supporting input and output devices 604, and communication interfaces 612. Example input and output devices 604 include keyboards, keypads, gesture or graphical input devices, motion input devices, touchscreen interfaces, one or more displays, audio units, voice recognition units, vibratory devices, computer mice, and any other suitable user interface.

The processor 602 and memory 606 may include nonvolatile memory for storing computable-readable instructions, data, data structures, program modules, code, microcode, and other software components for storing the computer-readable instructions in non-transitory computable-readable mediums in connection with the other hardware components for carrying out the methodologies described herein. Software components may include source code, compiled code, interpreted code, executable code, static code, dynamic code, encrypted code, or any other suitable type of code or computer instructions implemented using any suitable high-level, low-level, object-oriented, visual, compiled, or interpreted programming language.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

1-20. (canceled)

21. A computer-implemented method for cross-issuer chargeback fraud detection using a cross-issuer chargeback fraud detection system, the computer-implemented method comprising:
receiving, by one or more processors of a cross-issuer fraud detection system, and transmitted using an Application Programming Interface (API) over a payment network, a fraud analysis request for one or more chargebacks from a plurality of issuers, wherein the fraud analysis request comprises a plurality of consumer transaction data associated with the one or more chargebacks from one or more payment vehicles associated with the plurality of issuers;
extracting, by the one or more processors of the cross-issuer fraud detection system, personally identifying information (PII) associated with the one or more payment vehicles and the plurality of consumer transaction data from the fraud analysis request;
determining, by the one or more processors of the cross-issuer fraud detection system, a fraud analysis profile in a profile database has not been generated based on the extracted PII associated with the one or more payment vehicles and the plurality of consumer transaction data from the fraud analysis request;
importing, by the one or more processors of the cross-issuer fraud detection system, historical chargeback data from a plurality of historical chargeback databases into temporary storage, wherein each of the plurality of historical chargeback databases stores chargeback data for a plurality of payment vehicles associated with one of the plurality of issuers;
transforming, by the one or more processors of the cross-issuer fraud detection system, the historical chargeback data from the plurality of historical chargeback databases by performing one or more of: data cleaning, data splitting, data translating, data merging, data moving, or data sorting to generate transformed historical chargeback data to be stored in a standard format;
storing, by the one or more processors of the cross-issuer fraud detection system, the transformed historical chargeback data in the standard format based on the transforming of the historical chargeback data from the plurality of historical chargeback databases;
generating, by the one or more processors of the cross-issuer fraud detection system, a fraud analysis profile for a defined time period comprising the transformed historical chargeback data;
storing, by the one or more processors of the cross-issuer fraud detection system, the fraud analysis profile in the profile database; and
based on generating the fraud analysis profile within the defined time period:
determining, by the one or more processors of the cross-issuer fraud detection system, one or more irregularity patterns within the plurality of consumer transaction data, the fraud analysis profile, and the one or more chargebacks;
generating, by the one or more processors of the cross-issuer fraud detection system, a multidimensional score for the one or more chargebacks based on the one or more irregularity patterns and one or more fraud alert parameters for detecting fraud in a future transaction based on the transformed historical chargeback data, wherein the fraud alert parameters include at least one of: a geographic restriction, a merchant restrictions, and a purchase amount restriction; and
transmitting, by the one or more processors of the cross-issuer fraud detection system and to a user interface associated with the plurality of issuers, a report including the one or more irregularity patterns, the multidimensional score, and the one or more fraud alert parameters.

22. The computer-implemented method of claim 21, wherein the multidimensional score includes a probability that the one or more chargebacks is fraudulent.

23. The computer-implemented method of claim 21, wherein the defined time period may be defined using a customizable input parameter transmitted by the plurality of issuers.

24. The computer-implemented method of claim 21, wherein determining the one or more irregularity patterns includes identifying patterns within the one or more chargebacks, spending irregularities, and suspicious activities included in the fraud analysis profile.

25. The computer-implemented method of claim 21, wherein the fraud analysis profile includes at least one of spending irregularities and suspicious activities associated with the plurality of consumer transaction data, the one or more chargebacks, an account identification associated with a consumer, or personally identifying information (PII) associated with the consumer.

26. The computer-implemented method of claim 25, wherein the spending irregularities are determined based on at least one of spending patterns of the consumer, a geographic region of an internet protocol (IP) address associated with the consumer, a billing address associated with the consumer, and a type of payment card associated with the consumer.

27. The computer-implemented method of claim 21, wherein the fraud analysis request comprises one or more transactions within a range of specified values of goods and services.

28. The computer-implemented method of claim 21, wherein the fraud analysis request further comprises an account identification associated with a consumer, transaction detail of the one or more chargebacks, and a type of the fraud analysis request for the one or more chargebacks, and wherein the PII comprises at least one of a name, an address, a social security number, and an email address.

29. The computer-implemented method of claim 21, wherein the one or more chargebacks are based on one or more duplicate billings, a return of a product, a fraudulent transaction, or a consumer request.

30. A system for cross-issuer chargeback fraud detection, the system comprising:
one or more processors of a cross-issuer fraud detection system; and
a memory storing executable instructions that, when executed by the one or more processors of the cross-issuer fraud detection system, perform a method including:
receiving, by the one or more processors of the cross-issuer fraud detection system, and transmitted using an Application Programming Interface (API) over a payment network, a fraud analysis request for one or more chargebacks from a plurality of issuers, wherein the fraud analysis request comprises a plurality of consumer transaction data associated with the one or more chargebacks from one or more payment vehicles associated with the plurality of issuers;
extracting, by the one or more processors of the cross-issuer fraud detection system, personally identifying information (PII) associated with the one or more payment vehicles and the plurality of consumer transaction data from the fraud analysis request;
determining, by the one or more processors of the cross-issuer fraud detection system, a fraud analysis profile in a profile database has not been generated based on the extracted PII associated with the one or more payment vehicles and the plurality of consumer transaction data from the fraud analysis request;
importing, by the one or more processors of the cross-issuer fraud detection system, historical chargeback data from a plurality of historical chargeback databases into temporary storage, wherein each of the plurality of historical chargeback databases stores chargeback data for a plurality of payment vehicles associated with one of the plurality of issuers;
transforming, by the one or more processors of the cross-issuer fraud analysis profile, the historical chargeback data from the plurality of historical chargeback databases by performing one or more of: data cleaning, data splitting, data translating, data merging, data moving, or data sorting to generate transformed historical chargeback data to be stored in a standard format;
storing, by the one or more processors of the cross-issuer fraud analysis profile, the transformed historical chargeback data in the standard format based on the transforming of the historical chargeback data from the plurality of historical chargeback databases;
generating, by the one or more processors of the cross-issuer fraud detection system, a fraud analysis profile for a defined time period comprising the transformed historical chargeback data;
storing, by the one or more processors of the cross-issuer fraud detection system, the fraud analysis profile in the profile database; and
based on generating the fraud analysis profile within the defined time period:
determining, by the one or more processors of the cross-issuer fraud detection system, one or more irregularity patterns within the plurality of consumer transaction data, the fraud analysis profile, and the one or more chargebacks;
generating, by the one or more processors of the cross-issuer fraud detection system, a multidimensional score for the one or more chargebacks based on the one or more irregularity and one or more fraud alert parameters for detecting fraud in a future transaction based on the transformed historical chargeback data, wherein the fraud alert parameters include at least one of: a geographic restriction, a merchant restrictions, and a purchase amount restriction; and
transmitting, by the one or more processors of the cross-issuer fraud detection system and to a user interface associated with the plurality of issuers, a report including the one or more irregularity patterns, the multidimensional score, and the one or more fraud alert parameters.

31. The system of claim 30, wherein the multidimensional score includes a probability that the one or more chargebacks is fraudulent.

32. The system of claim 30, wherein the defined time period may be defined using a customizable input parameter transmitted by the plurality of issuers.

33. The system of claim 30, wherein determining the one or more irregularity patterns includes identifying patterns within the one or more chargebacks, spending irregularities, and suspicious activities included in the fraud analysis profile.

34. The system of claim 30, wherein the fraud analysis profile includes at least one of spending irregularities and suspicious activities associated with the plurality of consumer transaction data, the one or more chargebacks, an account identification associated with a consumer, or personally identifying information (PII) associated with the consumer.

35. The system of claim 34, wherein the spending irregularities are determined based on at least one of spending patterns of the consumer, a geographic region of an internet protocol (IP) address associated with the consumer, a billing address associated with the consumer, and a type of payment card associated with the consumer.

36. The system of claim 30, wherein the fraud analysis request comprises one or more transactions within a range of specified values of goods and services.

37. The system of claim 30, wherein the fraud analysis request further comprises an account identification associated with a consumer, transaction detail of the one or more chargebacks, and a type of the fraud analysis request for the one or more chargebacks, and wherein the PII comprises at least one of a name, an address, a social security number, and an email address.

38. A non-transitory computer readable medium for use on a cross-issuer fraud detection computer system containing computer-executable programming instructions for performing a method of cross-issuer chargeback fraud detection, the method comprising performing, by the cross-issuer fraud detection computer system, operations including:
receiving, by one or more processors of cross-issuer fraud detection computer system, and transmitted using an Application Programming Interface (API) over a payment network, a fraud analysis request for one or more chargebacks from a plurality of issuers, wherein the fraud analysis request comprises a plurality of consumer transaction data associated with the one or more chargebacks from one or more payment vehicles associated with the plurality of issuers;
extracting, by the one or more processors of the cross-issuer fraud detection computer system, personally identifying information (PII) associated with the one or more payment vehicles and the plurality of consumer transaction data from the fraud analysis request;
determining, by the one or more processors of the cross-issuer fraud detection computer system, a fraud analysis profile in a profile database has not been generated based on the extracted PII associated with the one or more payment vehicles and the plurality of consumer transaction data from the fraud analysis request;
importing, by the one or more processors of the cross-issuer fraud detection computer system, historical chargeback data from a plurality of historical chargeback databases into temporary storage, wherein each of the plurality of historical chargeback databases stores chargeback data for a plurality of payment vehicles associated with one of the plurality of issuers;
transforming, by the one or more processors of the cross-issuer fraud detection computer system, the historical chargeback data from the plurality of historical chargeback databases by performing one or more of: data cleaning, data splitting, data translating, data merging, data moving, or data sorting to generate transformed historical chargeback data to be stored in a standard format;
storing, by the one or more processors of the cross-issuer fraud detection computer system, the transformed historical chargeback data in the standard format based on the transforming of the historical chargeback data from the plurality of historical chargeback databases;
generating, by the one or more processors of the cross-issuer fraud detection computer system, a fraud analysis profile for a defined time period comprising the transformed historical chargeback data;
storing, by the one or more processors of the cross-issuer fraud detection computer system, the fraud analysis profile in the profile database; and
based on generating the fraud analysis profile within the defined time period:
determining, by the one or more processors of the cross-issuer fraud detection computer system, one or more irregularity patterns within the plurality of consumer transaction data, the fraud analysis profile, and the one or more chargebacks;
generating, by the one or more processors of the cross-issuer fraud detection computer system, a multidimensional score for the one or more chargebacks based on the one or more irregularity patterns and one or more fraud alert parameters for detecting fraud in a future transaction based on the transformed historical chargeback data, wherein the fraud alert parameters include at least one of: a geographic restriction, a merchant restrictions, and a purchase amount restriction; and
transmitting, by the one or more processors of the cross-issuer fraud detection computer system and to a user interface associated with the plurality of issuers, a report including the one or more irregularity patterns, the multidimensional score, and the one or more fraud alert parameters.

39. The non-transitory computer readable medium of claim 38, wherein the multidimensional score includes a probability that the one or more chargebacks is fraudulent.

40. The non-transitory computer readable medium of claim 38, wherein the defined time period may be defined using a customizable input parameter by the plurality of issuers.
